(19) United States
(12) Patent Application Publication
(10) Pub. No.: US 2025/0371533 A1
(43) Pub. Date: Dec. 4, 2025

(54) SYSTEM AND METHOD FOR SHARING PAYMENTS FOR COMMUNICATION SERVICES

(71) Applicant: AT&T Intellectual Property I, LP, Atlanta, GA (US)

(72) Inventor: Peter Crosby, Titusville, FL (US)

(73) Assignee: AT&T Intellectual Property I, LP, Atlanta, GA (US)

(21) Appl. No.: 18/733,121

(22) Filed: Jun. 4, 2024

(51) Int. Cl. G06Q 20/40; G06Q 20/32

(52) U.S. Cl. CPC G06Q 20/40; G06Q 20/3278

(57) ABSTRACT

Aspects of the subject disclosure may include, for example, providing, to a subscriber to communication services, an interface, the interface accessible over a communication network, the subscriber associated with a subscription account for the communication services, receiving, from the subscriber, information defining one or more designated payers, each designated payer of the one or more designated payers being responsible for payment of a designated portion of amounts due for payment to the subscription account for the communication services, communicating, to each designated payer, a communication indicating a designated amount due from the designated payer and a payment mechanism, receiving from the designated payer, an authorization of payment of the designated amount through the payment mechanism and crediting the subscription account according to the authorization of payment. Other embodiments are disclosed.

### FIELD OF THE DISCLOSURE

The subject disclosure relates to a system and method for sharing payments for communication services.

### BACKGROUND

Communication services include wireless communication services, internet access services, landline telephone services, cable television services, and others. Such services are usually provided on a subscription basis. A subscriber pays a service provider a fee periodically, such as monthly, for provision of the service at one or more locations or devices of the subscriber. Multiple users may share access to the communication services.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B depicts several views of an illustrative embodiment of a user interface for a payment sharing system for a communications network operator and subscriber in accordance with various aspects described herein.

FIG. 2C depicts several views of an illustrative embodiment of a user interface for a payment sharing system for a communications network operator and subscriber in accordance with various aspects described herein.

FIG. 2D depicts several views of an illustrative embodiment of a user interface for a payment sharing system for a communications network operator and subscriber in accordance with various aspects described herein.

FIG. 2E depicts several views of an illustrative embodiment of a user interface for a payment sharing system for a communications network operator and subscriber in accordance with various aspects described herein.

FIG. 2F depicts a view of an illustrative embodiment of a user interface for a payment sharing system for a communications network operator and subscriber in accordance with various aspects described herein.

FIG. 2G depicts user communications and online operations of a payment sharing system for a communications network operator and subscriber in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for a subscriber or designated account holder for a subscription account for communication services to designate users who share the account and who are designated payers to make payments on the account. Multiple users can be grouped together with a designated payer for the group. When payment is due, a message is sent to the designated payers to prompt payment. The message includes a link or other payment mechanism so the designated payer can authorize payment into the shared subscription account for the designated portion of the amount due. Other embodiments are described in the subject disclosure.

One or more aspects of the subject disclosure include providing, to a subscriber to communication services, an interface, the interface accessible over a communication network, the subscriber associated with a subscription account for the communication services, receiving, from the subscriber, information defining one or more designated payers, each designated payer of the one or more designated payers being responsible for payment of a designated portion of amounts due for payment to the subscription account for the communication services, communicating, to each designated payer, a communication indicating a designated amount due from the designated payer and a payment mechanism, receiving from the designated payer, an authorization of payment of the designated amount through the payment mechanism and crediting the subscription account according to the authorization of payment.

One or more aspects of the subject disclosure include sending, to designated payers responsible for designated portions of amounts due for payment to a subscription account associated with a subscriber for communication services, a communication indicating a designated amount currently due for payment to the subscription account from each designated payer, the communication further indicating a payment mechanism for actuation by the designated payer, receiving, from the designated payer, an authorization of payment through the payment mechanism, and crediting the subscription account according to the authorization of payment.

One or more aspects of the subject disclosure include receiving, from a subscriber associated with a subscription account shared by a plurality of users for accessing communication services, information defining one or more designated payers, each designated payer of the one or more designated payers being responsible for payment of a designated portion of amounts due for payment to the subscription account, communicating periodically according to a billing cycle for the subscription account, to each designated payer, a payment communication indicating a designated amount due from the designated payer, the payment communication including a payment mechanism which may be actuated by the designated payer for completing a payment of the designated amount to the subscription account; receiving, by the processing system, from the each designated payer, an authorization of payment of the designated amount through the payment mechanism, and crediting, by the processing system, the subscription account according to the authorization of payment.

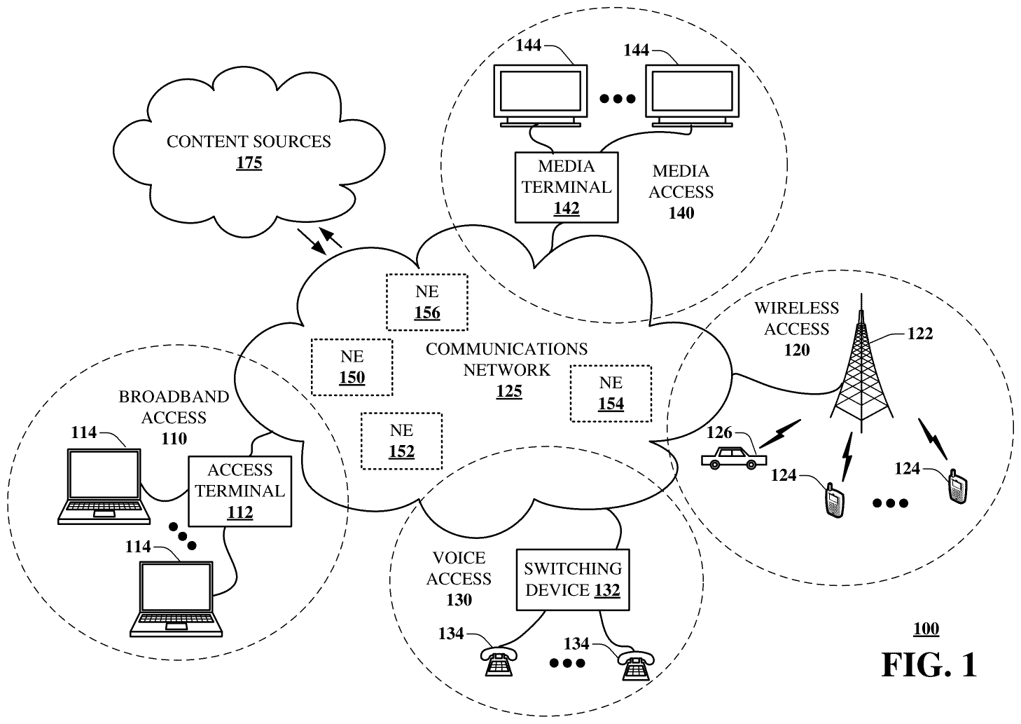

Referring now to FIG. 1, a block diagram is shown illustrating an example, non-limiting embodiment of a system 100 in accordance with various aspects described herein. For example, system 100 can facilitate in whole or in part designating payers among the users who share an account for communication services and who are authorized to make payments for amounts due for the shared account. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

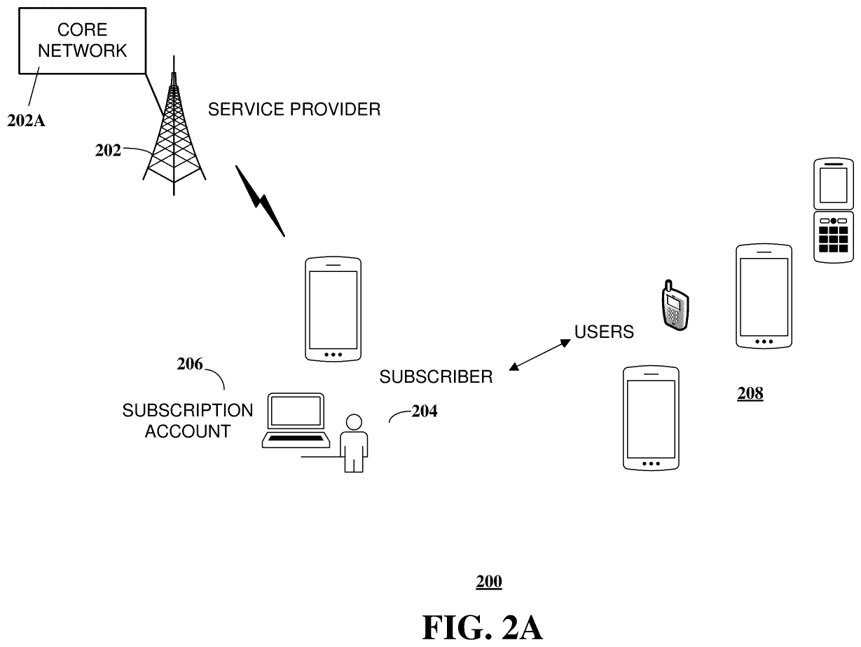

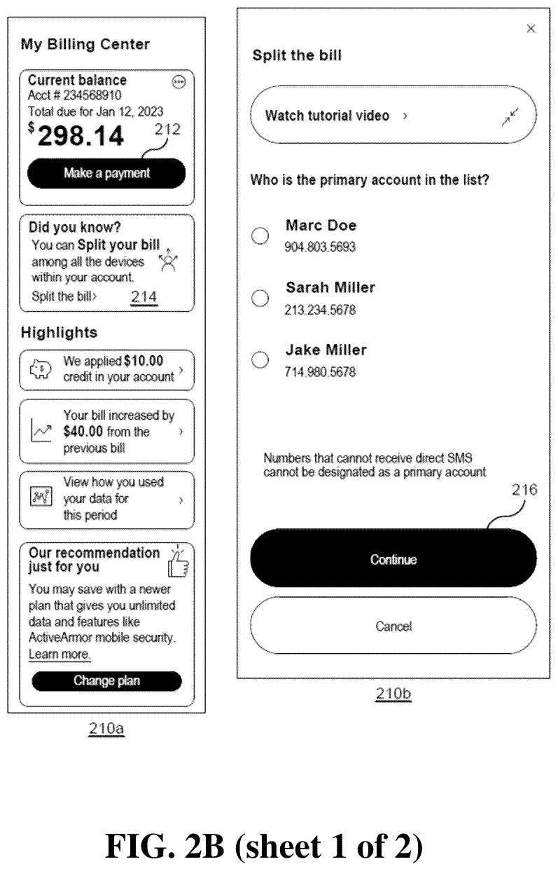

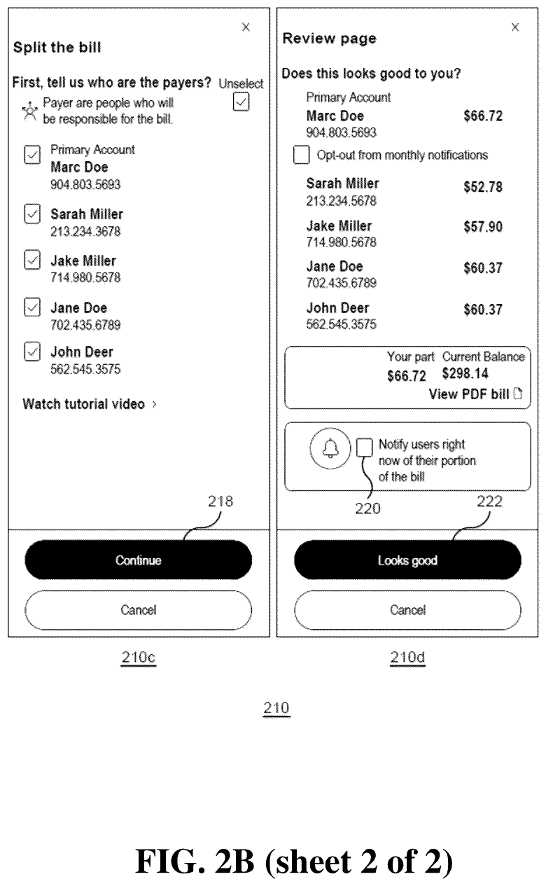

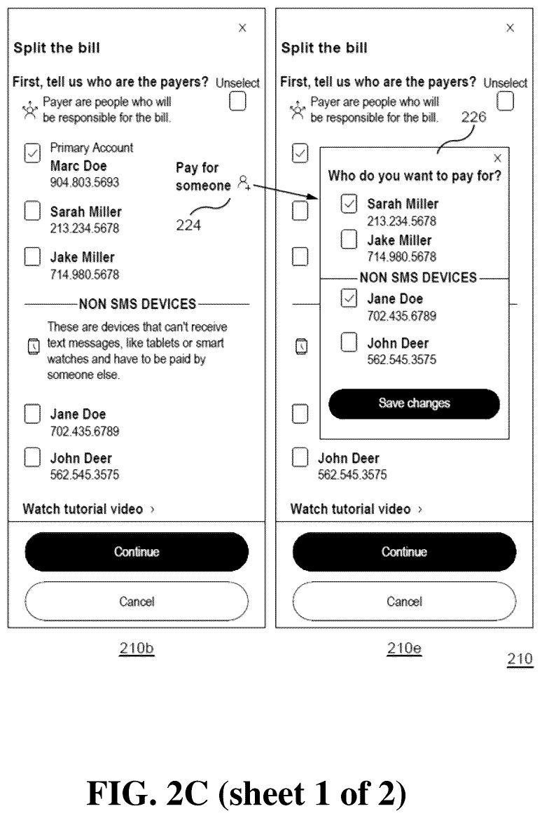

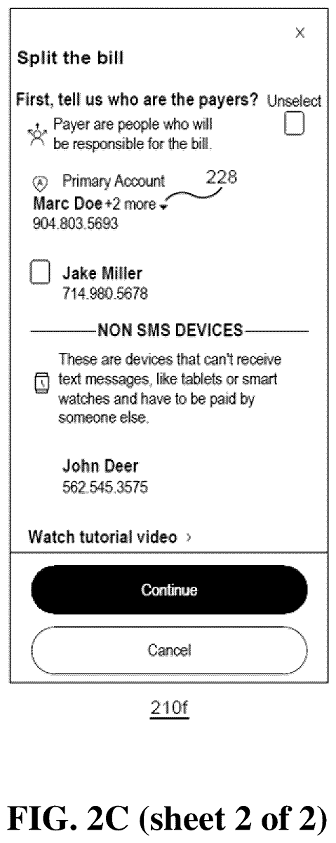

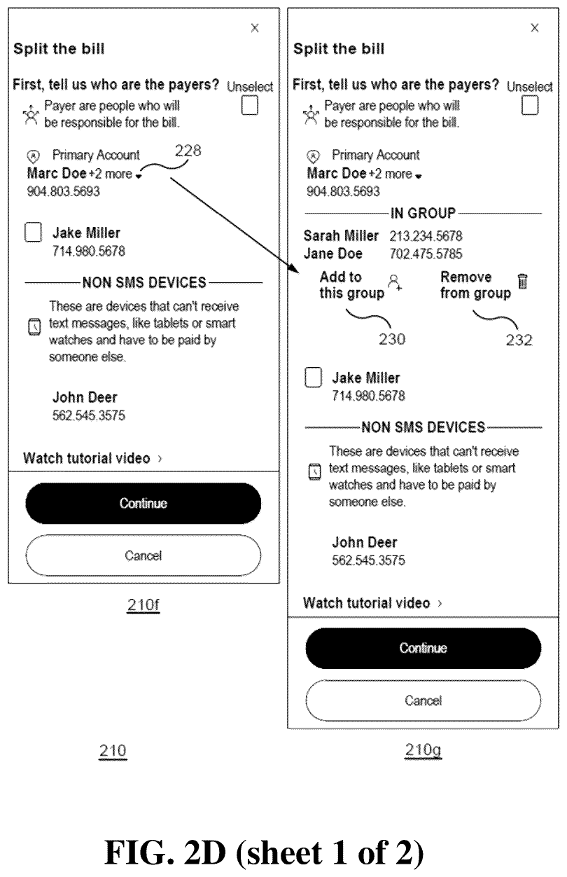

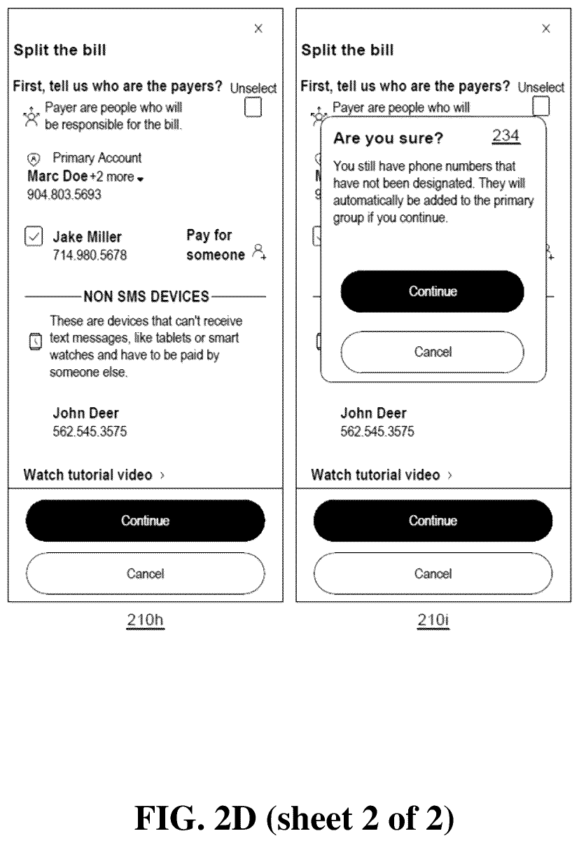

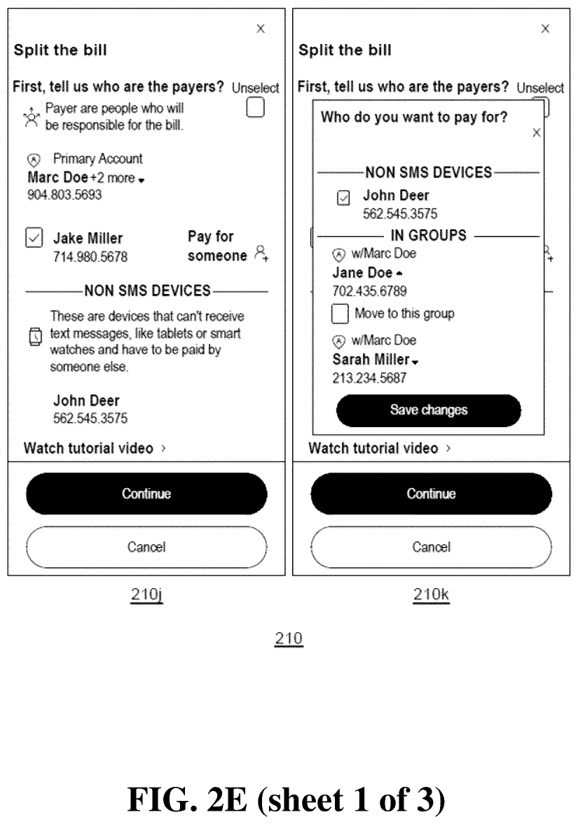

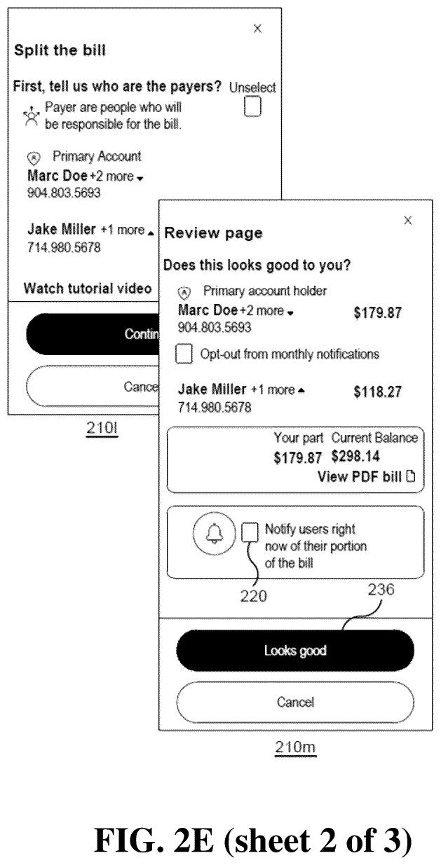

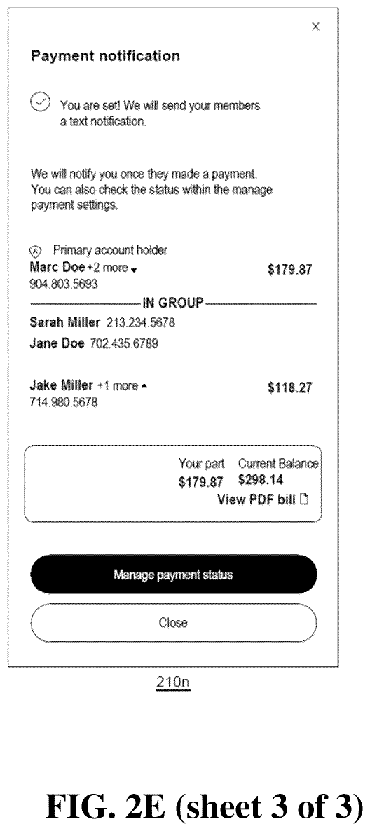

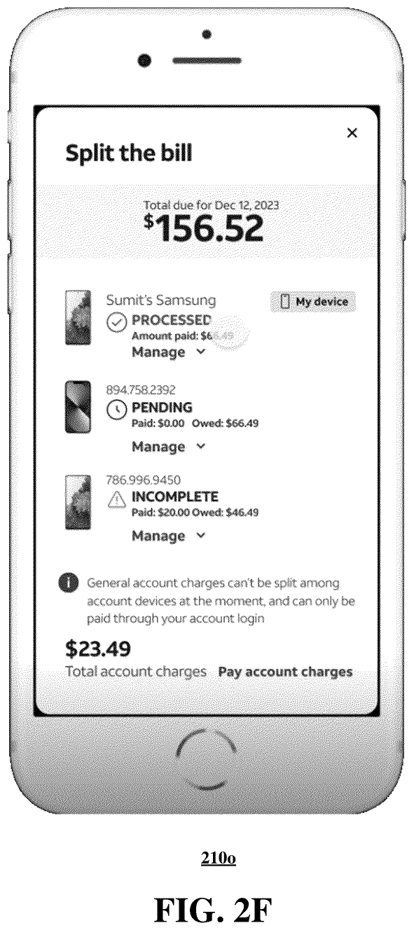

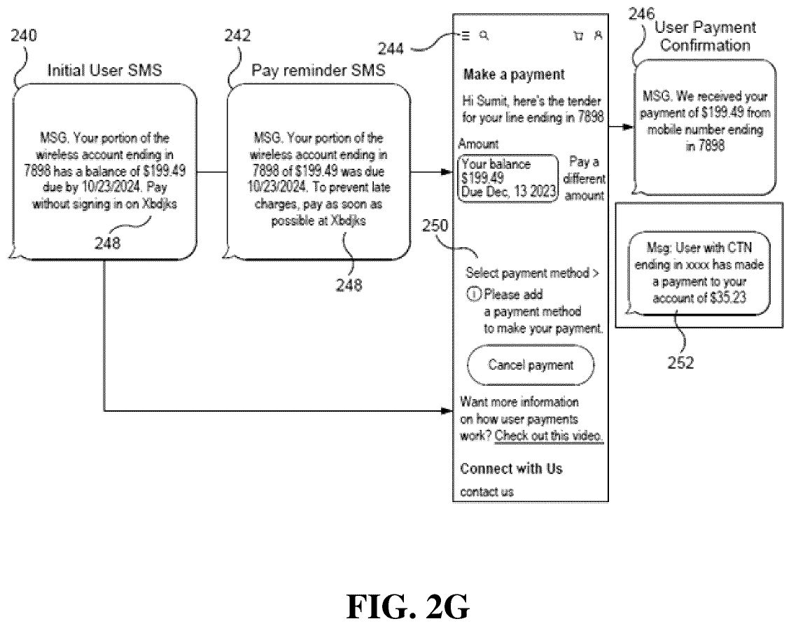

FIG. 2A is a block diagram illustrating an example, non-limiting embodiment of a system 200 functioning within the communications network of FIG. 1 in accordance with various aspects described herein. The system 200 illustrates an exemplary relationship between a service provider 202, a subscriber 204 who maintains a subscription account 206 for communication services provided by the service provider 202, and other users 208 who access the communication services of the service provider 202 through the subscription account 206 of the subscriber 204. The subscriber 204 pays for the subscription account 206 with the service provider 202 and in return, receives access to one or more communication networks of the service provider. The one or more communication networks may include, for example, one or more of broadband access 110, wireless access 120, voice access 130, media access 140 or content sources 175 illustrated in FIG. 1. Associated with the service provider 202 is a core network 202a which provides functions such as accounting, subscriber account management, mobility management, and others as well.

The subscription account 206 sets out terms of the agreement between the service provider and the subscriber. Terms include definitions of the service provided, the fee for service, and identification information for authorized users 208. The fee may be assessed in any suitable manner, such as monthly. Authorized users 208 may include the subscriber 204 only, members of the family of the subscriber 204, business associates of the subscriber, and others. The subscriber 204 and the users 208 may be identified in any suitable manner including by use of a mobile number assigned to user equipment (UE) such as a mobile phone number or cellular telephone number (CTN), an electronic serial number (ESN) assigned to the UE, or any other suitable device or identifier.

The UEs of the subscriber 204 and the users 208 may access one or more networks of the service provider 202 for communication services as part of the subscription agreement. In general, the subscriber 204 agrees with the service provider 202 to be financially responsible for the subscription account 206, including payment of the subscription fee, for services provided to the UEs of the subscriber 204 and the users 208.

In turn, the subscriber 204 and the users 208 may have their own private arrangement among themselves for sharing the costs of the subscription account 206. In one example, the subscriber 204 may be a head of household and the family shares a common subscription account 206. The spouse of the subscriber 204, children, grandchildren and others in the family, whether living in the same residence or not, may be among the users 208 who access the service provider using the common account of the subscription account 206 of the subscriber 204. Each month or other billing period, the service provider 202 sends a bill or statement to the subscriber 204 and the subscriber 204 arranges for payment to be made to the service provider 202. Many other examples apply.

In survey data, one network operator has determined that 39% of subscribers to a mobile communication service split their payments among the subscriber and other users. The subscriber receives a bill for service and in 39% of cases, expects others to pay a portion of that bill. Of that percentage, 84% are family members and 66% are of different generations including children, grandparents, etc. Moreover 46% of the payment splitting respondents report that at least one user on the account lives in a separate households from the subscriber and 28% report that at least one user on the account lives in another state from the subscriber. The users each have respective lines and devices associated with the subscription account of the subscriber. Among the subscriber and the users, they work out an arrangement for payment to the subscriber who is responsible for and makes the payment to credit the subscription account.

Conventionally, the subscriber 204 must manage apportioning the costs among the users 208, collecting from each of them and ensuring the service provider 202 was paid according to the subscription account. For example, this could include the following actions by the subscriber 204:
1. reviewing the bill
2. adding up totals for users who are expected to pay.
3. reaching out to the users 208 and advising how much money they owe.
4. work out with the users 208 how and when they are going to pay.
5. each user separately sends payment to the subscriber 204.
6. The subscriber 204 then pays the full bill for the subscription account 206 to the service provider 202.

This conventional system and arrangement create substantial additional work for the subscriber 204. There is substantial motivation for the network operator to provide a simpler, more streamlined payment system and method for the subscriber and other users. An improved system for billing and payment would reflect how the users are sharing the account and responsibility for payment on the account. The improved system would eliminate many of these steps and simplify the process of payment by each of the different users. The improved system would enable the subscriber to set up how payment is made to the subscription account 206 and manage which of the users is charged and how much the total charge is apportioned. The improved system would report back to the subscriber 204 status information about payments that have been made or are yet to be made by the users 208. The motivation for the network operator is to provide good customer service and a good customer experience, to simplify and reduce the cost of billing and collecting, and to create a channel for offering future capabilities and communicating with customers.

FIG. 2B depicts several views of an illustrative embodiment of a user interface 210 for a payment sharing system for a communications network operator and subscriber in accordance with various aspects described herein. The embodiment of user interface 210 illustrated in FIG. 2B may be viewed on a user device of a user, in particular an account owner such as subscriber 204. The user interface 210 may be presented by and controlled by an application program or app running on the user device of the subscriber. The app may provide user functions such as bill payment, service selection and upgrading, shopping for new devices and notifications to the user about, for example, product offers or service outages. FIG. 2B illustrates an exemplary series of images illustrating a chronological set of screens or displays that may be viewed by a subscriber, for example, on the display of a smartphone. The smartphone is used for accessing service of a service provider such as service provided 202. A smartphone is one example of a user device that may be used to enroll in a payment sharing system. Any other suitable device may be used by a user for access, including a desktop computer and a tablet computer, for example.

Display 210a displays a billing center page to the subscriber. The billing center page in this embodiment includes a make a payment button 212 and a split your bill section 214. The make a payment button 212 corresponds to a hyperlink that activates a process in the user device to display a bill payment page for interaction by the subscriber. The bill payment page allows the subscriber to make a payment to be credited to the subscription account of the subscriber with the service provider. The split your bill section 214 includes a hyperlink to take the subscriber to a page such as display 210b. The billing center page of display 210a may include any other suitable information such as news, product offers, service offers, and other information targeted at the subscriber.

Display 210b displays a split the bill page. The split the bill page includes a selectable listing of users associated with the subscription account of the subscriber. In the example, three users are listed with their names and cellular telephone numbers, along with selectable buttons by each name. The selectable buttons allow the subscriber to individually select which user is considered or designated as the primary payer. Text on the split the bill page advises that only cellular telephone numbers that can receive a short message service (SMS) message can be designated as the primary payer. SMS messaging may be specified as the primary or exclusive manner of communication between the user device of the subscriber and the network. A continue button 216 allows the subscriber to continue to further steps.

Display 210c shows a payer identifier page. Text on the payer identifier page prompts the subscriber to identify who should be responsible for making payments for service on the subscription account. In the example, five users and their cellular telephone numbers are listed on the display 210c, along with selection buttons for the subscriber to select individual users to be designated to pay a portion of the bill. On both the split the bill page and the payer identifier page, the subscriber is offered a link to view a tutorial video to explain the feature that allows sharing payment for services. A continue button 218 allows the subscriber to continue to further steps.

Display page 210d shows a review page. In the example, the review page repeats the selections made by the user on the payer identifier page of display 210c. In particular, the review page lists the name associated with the primary payer as well as the four other payers selected by the subscriber. Further, the review pages lists payment amounts for which the respective payers are responsible, as well as a total amount due. The review page further includes a user notification button 220 along with text inviting the subscriber to select a check box in order to immediately notify the payers of their portion of the bill which is due. If the check box is not selected by the subscriber, the notification may be made later or elsewhere, such as according to a profile of the subscriber maintained by the service provider. The review page still further includes a user notification button 222 which invites the subscriber to confirm the selections made by the subscriber.

FIG. 2C depicts several views of an illustrative embodiment of the user interface 210 for a payment sharing system for a communications network operator and subscriber in accordance with various aspects described herein. FIG. 2C illustrates an exemplary series of images illustrating a chronological set of screens or displays that may be used by a subscriber, for example, to setup up grouping of users in the payment sharing system. For example, users may be associated in particular ways so that allowing one user to pay for their own service plus one or more other user's service enhances convenience for the users. In one example, the subscriber and primary account holder is a head of household. His family includes a spouse and two children. He also has his sister's cell phone on his account, along with the cell phones of her two children. Thus, the head of household as subscriber may group the sister with her two children and designate the sister as the payer for that group of users. Other examples may be specified as well.

In FIG. 2C, display 210b displays a split the bill page. In this example, the split the bill page include a link 224 inviting the subscriber who is organizing the shared payment of the account to pay for someone else. Actuation of the link 224 causes a popup menu 226 to appear in display 210e to enable the subscriber to manage grouping of users on the account for shared payment. The popup menu 226 in this example lists users associated with the account along with associated check boxes for selection by the subscriber accessing the display 210e.

Following the selection of one or more users by the subscriber accessing the popup menu 226, a modified version of the split the bill page is shown to the subscriber in display 210f. In the example, the name of the selected user is displayed with a link indicating how many additional users are grouped together with the selected user. In the example, the name “Marc Doe” of the selected user is shown adjacent to a link indicating “+2 more,” or two additional users in the group. The users who were grouped with the selected user on the popup menu of display 2e are not displayed on the modified version of the split the bill page of display 210f. Following acceptance of these selections by the subscriber, the two users will be grouped with the selected user “Marc Doe” for subsequent payment against the subscription account.”

FIG. 2D depicts several views of an illustrative embodiment of a user interface 210 for a payment sharing system for a communications network operator and subscriber in accordance with various aspects described herein. FIG. 2D illustrates an exemplary series of images illustrating a chronological set of screens or displays that may be used by a subscriber, for example, to edit an existing grouping of users in the payment sharing system.

In FIG. 2D, display 210f shows the modified version of the split the bill page in which the two users are grouped with the selected user “Marc Doe.” When the subscriber accessing the user interface 210 selects the link 228, display 210g reveals a group modification page in which the two additional members of the group are shown along with their CTNs. Moreover, the group modification page of display 210g shows a first link 230 prompting the subscriber to add additional users to the existing members of the group and a second link 232 prompting the subscriber to remove one or more members of the group.

In display 210h, the subscriber used the group modification page of display 210g to designate Jake Miller as the designated payer. For example, the subscriber may use the check box displayed next to the name of user Jake Miller in display 210g to designate Jake Miller as the designated payer. In display 210h, the subscriber is presented with a popup 234 advising that there is a user that has not been designated as a payer or assigned to a group, referring to user John Deer. The 234 popup is advising if the user continues, John Deer will automatically be assigned to the primary payer's group.

FIG. 2E depicts several views of an illustrative embodiment of a user interface for a payment sharing system for a communications network operator and subscriber in accordance with various aspects described herein. FIG. 2E illustrates an exemplary series of images illustrating a chronological set of screens or displays that may be used by a subscriber, for example, to complete enrollment in the payment sharing system. So as to not unduly complicate the drawing figure, FIG. 2E shows two displays including display 210m and display 210n, superimposed in part over three displays including display 210j, display 210k and display 210l.

Display 210j shows grouping of payer Jake Miller with user John Deer. The user interface 210 include text informing the subscriber that devices such as the device of John Deer that cannot receive text messages must be paid for by another user. Examples of such devices include tablets and wearable devices such as smart watches.

Display 210k shows additional information about the grouping of the users associated with the subscription account and affords an opportunity for the subscriber to change grouping. In the example, user Jane Doe is indicated to be in the same group as user Marc Doe. Similarly, user Sarah Miller is indicated to be in the same group as user Marc Doe. The selected user, indicated by the marked check box by the name of John Deer, is indicated as being available to move to the group including those users.

Display 210l shows available groups for bill payment. A first group is organized under the name of user Marc Doe and include 2 more members. A second group is organized under the name of user Jake Miller and include one more member.

The subscriber may select the group associated with Marc Doe in display 210l, indicating that the portion of the subscription account associated with the three users of that group is to be paid. At display 210m, a review page is displayed. The review page indicates the portion of the amount due ($298.14 in this example) attributable to each of the two groups. This includes $179.87 attributable to the group associated with user Marc Doe, also indicated as the primary account holder, and $118.27 attributable to the group associated with user Jake Miller. The review page of display 210m includes a checkbox 220 inviting the subscriber to send an immediate notification to the designated payers, advising of their portion of the current bill. The subscriber may click a confirmation button 236 to complete the process of setting up split billing notifications.

Display 210n shows a confirmation of the split billing assignments. Within this page users may view the final result of their assignments as well as be reminded when the notifications will be sent to the designated payers. In this example, the payment notification further identifies the other users grouped together in the group associated with user Marc Doe. Further, display 210n prompts the subscriber accessing the user interface 210 to manage payment status for other users as well as to check on the completion status for payments for the other users and other groups.

FIG. 2F depicts a view of an illustrative embodiment of a user interface 210 for a payment sharing system for a communications network operator and subscriber in accordance with various aspects described herein. The user interface 210 shows display 210o. Display 210o includes features to allow the subscriber to manage the payment sharing system. Display 210o shows and exemplary current billing cycle payment status and management page for a subscription account of the subscriber. In the example, the payment sharing system for this subscription account is set up for three payers and the display 210o shows the payment status for each payer. The payer designated as Sumit's mobile is indicated to show that the payment has been processed. Further Sumit's mobile is indicated as “my device,” corresponding to the user viewing the user interface 210.

Further, display 210o indicates that the payer designated as 894.758.2992 has a status of payment pending. Still further, display 210o indicates that the payer designated as 786.996.9450 has a status of incomplete. Still further in this example, the display 210o prompts the subscriber accessing the user interface 210 that “General account charges can't be split among account devices at the moment and can only be paid through your account login.” A link is included to provide access to one or more pages to pay the general account charges.

Thus, the payment sharing system and method provide features for managing the account and shared payments. The subscriber or primary account holder has access to dashboard information such as that shown in FIG. 2F. The dashboard information for the current billing cycle may include status information for each designated payer. The status information may include, for example, a status of “processed” may indicate payment has been approved by the designated payer and confirmed to the subscription account. A status of “pending” may indicate that the designated payer has not yet authorized that payment be made or that the subscription account has not been credited with the payment yet. A status of “incomplete” may indicate that the designated payer has authorized a partial payment which is less than the designated amount. This may alert the subscriber of a need to follow up with payers have a status other than “processed.”

In some embodiments, the user interface 210 or other display may be used to provide status information and other notices to the subscriber accessing the user interface 210. In other embodiments, user communications may be sent to a payer via text message and/or emails to the account holder and/or designated payers outside the graphical user interface. Examples include:

Per your request, we notified <#3>users on your account of their portion of the wireless bill, where <#3>is a variable amount to be filled in when the status message is provided.

You can view and manage user notifications at any time online, where the underlined text corresponds to a hyperlink to another page viewable on the user interface.

Important: the account holder is responsible for paying the full balance on time. View frequently asked questions.

We now have a way for you to notify users of their amount due. Interested? Check out our notification frequently asked questions.

An automatic reminder SMS was sent to any users who still have not made a complete payment. Need more details? Check your notifications.

FIG. 2G depicts user communications and online operations of a payment sharing system for a communications network operator and subscriber in accordance with various aspects described herein. FIG. 2G depicts an embodiment of an initial user SMS message 240 and a payment reminder SMS message 242, along with a display 244 and a user payment confirmation message 246.

An accounting function of the service provider determines that a payment is due, the amount of the payment, and identifies a designated payer or payers. The payer and the amount may be according to selections made by an account owner or primary payer, for example using a process as illustrated in FIG. 2B, FIG. 2C, FIG. 2D and FIG. 2E. The accounting function may further determine a payment due date or other timing information. At a time indicated by the payment due date, the service provider sends a communication to the payer advising the payer that the payment is due. In the example, the communication is in the form of initial user SMS message 240. The SMS message is transmitted by the service provider over the communication network to a user device such as a smartphone of the user who is the payer.

In the example, the initial user SMS message 240 includes text identifying the account number, the amount due and a due date. The SMS message may include more or less information. In general, financial information is maintained carefully confidential by the service provider. In this example, then, only a portion of the account number is provided in the initial user SMS message 240. The portion amount due, or the portion of the total amount due for the subscription account, is also displayed to the payer.

In another example, the user who is the payer has an application program or app operating on the user's smartphone, computer, tablet or other device. The app cooperates with a server program of the service provider which may operate, for example, on the core network of the network operator. When the payment becomes due, the server program and the app cooperate to provide a notification on the user device of the payer. The notification may be similar in content to the initial user SMS message 240 illustrated in FIG. 2G. The format may be similar, or the format may be varied. Generally, the app may have a look and feel that is consistent across products and services of the network operator and using an in-app notification may permit the network operator to provide a more customized or appealing presentation of the information in the initial user SMS message 240.

The initial user SMS message 240 further includes a payment link 248 to simplify the payment process for the payer. In embodiments, the payment link 248 contains or points to account related information such as the wireless number for the designated payer, an amount due on the account, log in credentials for the account, and any other suitable information. In some examples, the account related information may be encrypted or otherwise be maintained secure for user privacy. When the payer receives the initial user SMS message 240 in an SMS message or in a notification from the app, the payer may click the payment link 248 to initiate payment. Clicking the payment link 248 will contain encrypted details to identify the designated payer such as wireless number and postal code, which will then be used to launch a web browser on the device. The web browser application on the user device may be redirected the to a universal resource locator (URL) which the network operator has designated for a payment web page. Further, clicking the link may direct the web browser application the payment web page which does not require authentication steps such as providing a wireless number and password.

In FIG. 2G, the payment web page is shown on display 244. The payment web page may include any suitable information. In the example, the payment web page displays the amount due for the payment and includes a link 250 for the payer to specify a mode for payment such as an identifier for a credit card or a bank account.

The pay reminder SMS message 242 may optionally be sent by the service provider. For example, if a specified time has passed since the initial user SMS message 240 was sent to the payer, the service provider may automatically cause the pay reminder SMS message 242 to be sent. The pay reminder SMS message 242 may include any suitable information. In the example, the pay reminder SMS message 242 includes similar content as the initial user SMS message 240, including the account number, the amount due and the payment link 248 to the payment web page on display 244.

After completion of payment by the payer, the user payment confirmation message 246 is sent to the payer. In the example, the user payment confirmation message 246 is sent as an SMS message. In other embodiments, the user payment confirmation message 246 may be provided as a notification from the app on the user device of the payer, or in any other manner.

In the example of FIG. 2G, the network operator may further provide a notification message 252 to the subscriber or account holder. The notification may be made in any suitable form, such as an SMS message or an app notification. The notification may include any suitable information including identification information or cellular telephone number (CTN) for the payer, the amount paid, the account number and the time and date of payment.

Thus, in the example, the payer is presented with an unauthenticated payment state. Conventionally, when an account owner seeks to obtain account information or pay a bill on the account, the account owner must actually log in to the account, over the public internet for example. Typically, this requires entry of user credentials such as a username and password. Sometimes, two-factor authentication is supported for account access in which the service provider or other source sends an access code to the smartphone or other user device of the account holder and the account holder enters the access code and returns the access code to the service provider.

However, fully logging in to the account may be difficult or inconvenient for a user. It may be difficult to retain the account credentials. It may be difficult to log in to the web site. This is true for the account holder and may be true also for a user who has a user device active on the account. In general, if the user who is a payer for the account is accessing the account in only accessing account information to make a payment and receive confirmation of the payment, the user does not need full access to the account. If the user does not need full access, a more limited access state may be defined for the user.

Thus, the embodiment of FIG. 2G illustrates an unauthenticated payment flow. In a first step, the user accesses a payment interface such as the payment web page of display 244. Any other suitable payment interface may be provided. In a second step, the user provides account information. In the example of FIG. 2G, the account information may be contained in the payment link 248. Clicking the payment link 248 automatically passes the account information to a web browser application which is redirected to a payment website and the account information is automatically provided to the payment website. In a third step, the unauthenticated payment flow includes providing the payment amount. In the example of FIG. 2G, the payment amount may be included in or encoded in the payment link 248. After payment is completed, in a fourth step, confirmation of the payment and payment is made. In the example of FIG. 2G, the user payment confirmation SMS message provides the necessary confirmation to the payer.

In this example, the service provider already knows the account information for the payer including the account identification information and the payer's cellular telephone number. Thus, the service provider tokenizes this information, providing the account information and the payer's identification information as a token which may be passed to the payment website when the user clicks on the payment link 248 in the initial user SMS 240 or the pay reminder SMS 242. This corresponds to unique account information identifying the designated payer. The information in the token is used to populate one or more fields of the payment web page or other payment interface. In this manner, the payer is taken directly to the third step of the unauthenticated payment flow. Further, although the account balance amount is confidential information, since the balance is provided in the initial user SMS message 240, the balance amount may be shown to the payer during the payment step.

In accordance with some embodiments, the system and method for sharing payments may be limited to certain subscription account types. In some account types referred to as mobile share plans, a bill for the account is broken down by usage type including data usage and voice usage and a number of users on the account. In some other account types referred to as unlimited plans, a bill for the account is broken out according to usage per user. In such an account type, the initial user or subscriber may be billed at one rate, such as $100 per month. Each subsequently added user may be billed at a second, reduced rate such as $20 per month. With an unlimited plan, the bill may be organized and presented for each respective user. With that information, presentation of the system for sharing payments becomes more straightforward. The amount owed for each user is readily discernible and may be selected and formatted as a bill amount for each payer, including grouping individual user amounts in a group to be paid by one user.

In alternative embodiments, the portion of a monthly (or other periodic) bill payable by each shared payments participant may be selected or specified by the account holder or subscriber. In an example, if four users and four user devices or four CTNs are associated with the account, the subscriber or account holder may indicate that each user is responsible for 25% of the total bill each month. In another example, the subscriber may indicate that the subscriber is responsible for 50% of the billed amount, user A and user B are each responsible for 25% of the billed amount, and user C is responsible for 0% of the billed amount. In yet another example, the subscriber or account holder may indicate that the subscriber is responsible for 100% of monthly fees and taxes plus 25% of variable monthly usage charges, and each of the other three users responsible for 25% of the usage charges. Any arrangement required by the customer may be accommodated. For example, one or more users may be assigned a fixed amount to pay each month, such as $25.

In an embodiment, the subscriber may be given login access to a website of the service provider to set up and modify percentage amounts or fixed amounts payable by each user. The website may provide for the subscriber to define user nicknames or other identifiers for the users on the account. The subscriber may use the website to control payment options for himself and users. For example, the subscriber may associate a bank account with the subscription account for payment of the amounts billed to the subscriber, as well as a credit card for payments of these amounts. The subscriber may set up a default payment source such as a bank account or credit card so that if one or more payers is delinquent with a designated payment, the default payment source is accessed. This may serve as a prevention against missed payments and late fees that may be assessed against the account.

In another example, the website may give the subscriber access to historical payment information for the overall account as well as for each respective payer. This can help the account holder manage the account with full awareness over time. In another example, the account holder may be given options to customize presentation of account information. In one option, the account holder may select and be presented with a full breakdown of a current month's charges for the account. In a second option, the account holder may be presented with a minimal presentation showing just the current total amount, the current share billed to the subscriber, and variances from the previous month.

In still another example, the account holder or the individual payers may set up automatic payments. Each user, including the subscriber, may access the account information to specify a bank account identifier or a credit card identifier which should be used to pay the user's portion of the bill each month. In an example, the account holder logs in to the account and specifies automatic payment information for the account holder's portion of the amount due. Further, the account holder specified on the website that automatic payment may be set up for the individual payers. In response, the accounting function of the service provider may send an SMS invitation message to each payer inviting them to set up automatic payment and providing a link for access. Upon selecting the provided link, a web browser of the payer may be redirected to a limited functionality website to provide the necessary automatic payment information. An unauthenticated payment flow may be used to provide the payers access to the limited functionality website based on the existing account number and identification information for the payer.

In a still further example, the payment sharing system and method may be extended to other types of services that are billed in other fashions. For example, services such as internet service and cable television may be billed as a flat rate plus a variable rate for additional items that are accessed, such as movies that are rented or online games that are played. Such services are generally provided to a single destination such as a residence or business. In accordance with various aspects described herein, an account for such services may have a primary account holder or subscriber who desires to share payment with other residents such as roommates, for example. The principles described herein may be readily extended to such other services. For example, for each roommate, a user device must be identified that can receive SMS messages and access a website via a web browser application to make the assigned payment. Further, each user of any service can also be associated with an email address which can be designated for primary communications or backup communications from the service provider.

In a further example, users including the account holder or subscriber may participate in a text payment service where each month (or other period), the service provider sends to the user a text or SMS message regarding payment. The SMS message specifies the amount due and provides a simple option to accept or confirm payment such as a direct payment actuator. As part of initiating the service, the user specifies a payment source such as a bank account or credit card and provides the user's wireless number. The option to confirm payment may be responding with the number 1 in a reply SMS message, or any other specific response serving as a direct payment actuator which may be actuated by the payer to confirm the payment. In an alternative, the payment sharing system and method include providing in the SMS message from the service provider to the user two options. The first option provides access to the payment web page as shown, for example, on display 244 of FIG. 2G. The second option enables the user to make the payment in the amount indicated in the SMS message simply by responding with the indicated option, such as by responding with the number 1 in the reply SMS message. This second option avoids the payment flow of the first option.

In a yet further example, each user or line associated with the subscription account may be set up for automatic payment from an account specified by the user. The account holder or subscriber can set up an automatic payment account for the subscriber's portion of the bill. Further, the subscriber can activate automatic payment for one or more of the users on the account. The users, in turn, may elect the automatic payment option for payment of their portions of the bill. Each month or other period, the service provider sends to a user a SMS message similar to initial user SMS 240 advising that the specified amount is due. The SMS message may present two options. In the first option, the user can click a payment link such as payment link 248 and go through a payment flow as illustrated in FIG. 2G. In the second option, the user can rely on the automatic payment arrangement that has been established.

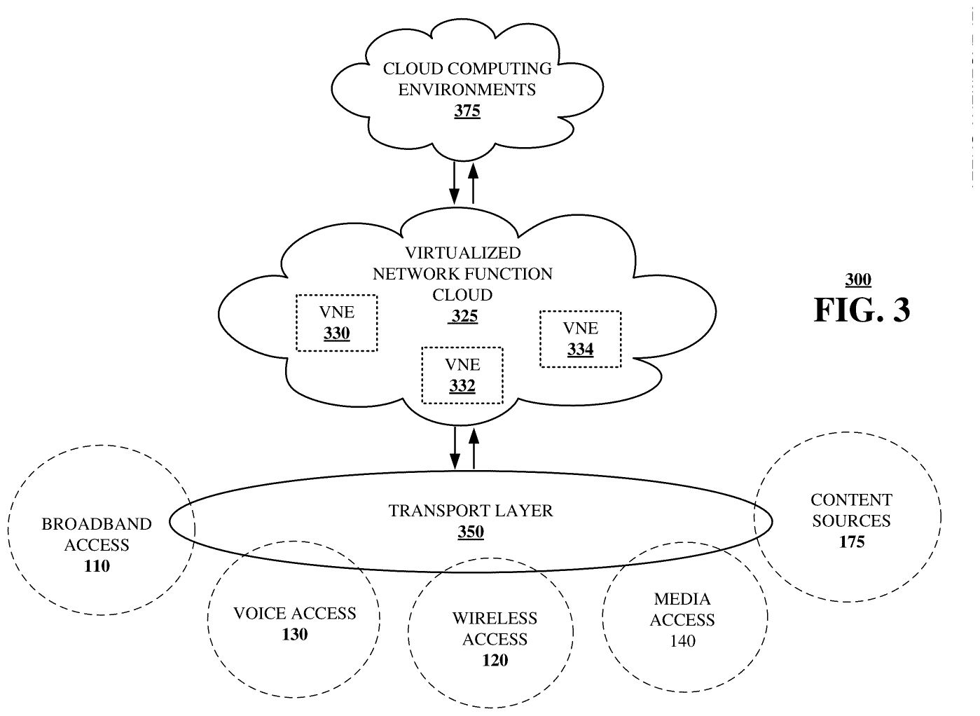

Referring now to FIG. 3, a block diagram is shown illustrating an example, non-limiting embodiment of a virtualized communication network in accordance with various aspects described herein. In particular a virtualized communication network 300 is presented that can be used to implement some or all of the subsystems and functions of system 100, the subsystems and functions of system 200, and method 230 presented in FIG. 1, FIG. 2A, FIG. 2B, FIG. 2C, FIG. 2D, FIG. 2E, FIG. 2F, FIG. 2G and 3. For example, virtualized communication network 300 can facilitate in whole or in part designating payers among the users who share an account for communication services on the virtualized communication network 300 or another network and who are authorized to make payments for amounts due for the shared account.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

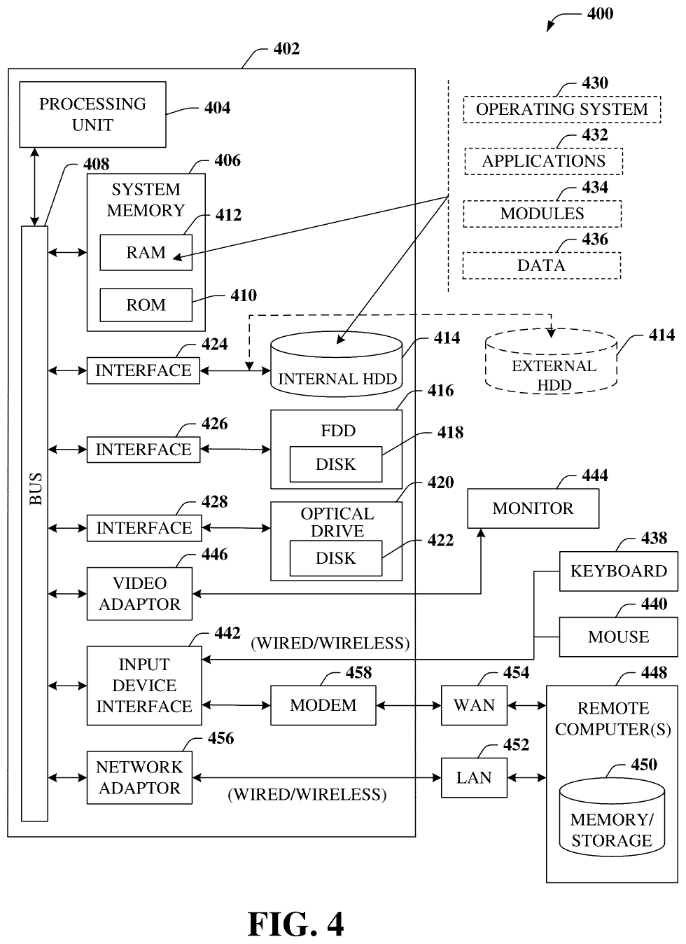

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part designating payers among users who share an account for communication services and who are authorized to make payments for amounts due for the shared account.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

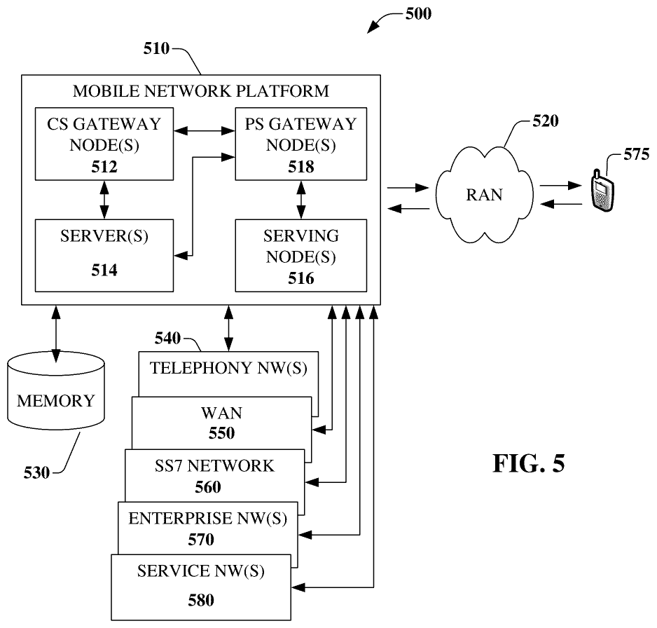

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part designating payers among the users who share an account for communication services on the mobile network platform 510 and who are authorized to make payments for amounts due for the shared account. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

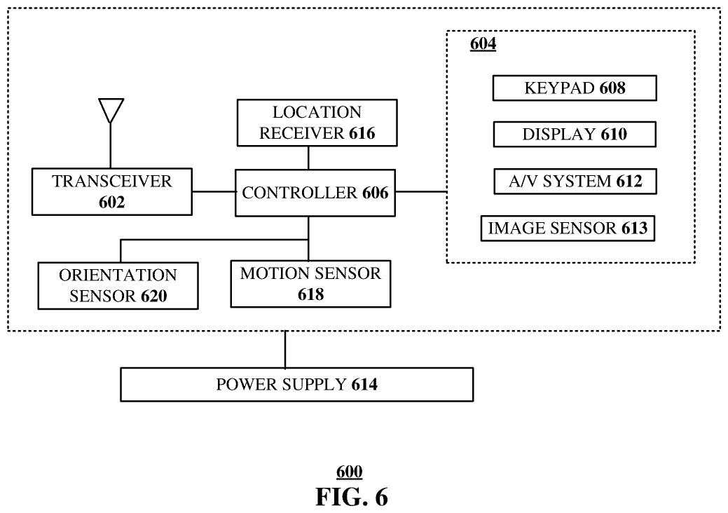

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part designating payers among the users who share an account for communication services and who are authorized to make payments for amounts due for the shared account and providing to the designated payers at a user device such as communication device 600 a payment message prompting payment by the designated payer and a payment mechanism such as a clickable link in the payment message.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

1. A device, comprising:
a processing system including a processor; and
a memory that stores executable instructions that, when executed by the processing system, facilitate performance of operations, the operations comprising:
providing, to a subscriber to communication services, an interface, the interface accessible over a communication network, the subscriber associated with a subscription account for the communication services;
receiving, from the interface, information defining (1) a first payment group comprising a first designated payer and a non-payer and (2) a second payment group comprising a second designated payer,
wherein each of the first designated payer, the non-payer, and the second designated payer are associated with the subscription account for the communication services,
communicating to the interface, a visual indication of a first designated amount due for payment to the subscription account for the communication services attributed to the first payment group and a second designated amount due for payment to the subscription account for the communication services attributed to the second payment group;
communicating, to a first user device associated with the first designated payer, a communication indicating the first designated amount due and a first payment mechanism;
communicating, to a second user device associated with the second designated payer, a communication indicating the second designated amount due and a second payment mechanism;
receiving, from the first user device, an authorization of payment of the first designated amount due through the first payment mechanism; and
crediting the subscription account according to the authorization of payment of the first designated amount due.

2. The device of claim 1, wherein the operations further comprise:
communicating, as the first payment mechanism, a first message to the first user device, the first message including text identifying the first designated amount due from the first designated payer and a first payment link configured for selection at a user interface of the first user device, wherein the first payment link defines unique account information associated with the first designated payer;
receiving, from the first user device, responsive to selection of the first payment link, information including the unique account information associated with the first designated payer; and
communicating, to the first user device, a first web page, the first web page including a payment confirmation link which prompts payment of the first designated amount; and
receiving, from the first user device, responsive to selection of the first payment confirmation link, information confirming the authorization of payment of the first designated amount.

3. The device of claim 1, wherein the operations further comprise:
communicating, to the interface, information confirming receipt of the authorization of payment of the first designated amount due.

4. The device of claim 2, wherein the operations further comprise:
receiving, from the second user device, an authorization of payment of the second designated amount due through the second payment mechanism; and
crediting the subscription account according to the authorization of payment of the second designated amount due.

5. The device of claim 4, wherein the operations further comprise:
communicating, as the second payment mechanism, a second message to the second user device, the second message including text identifying the second designated amount due from the second designated payer and a second payment link configured for selection at a user interface of the second user device, wherein the second payment link defines unique account information associated with the second designated payer;
receiving, from the second user device, responsive to selection of the second payment link, information including the unique account information associated with the second designated payer; and
communicating, to the second user device, a second web page, the second web page including a payment confirmation link which prompts payment of the second designated amount; and
receiving, from the second user device, responsive to selection of the second payment confirmation link, information confirming the authorization of payment of the second designated amount.

6. The device of claim 1, wherein the receiving information defining the first and second payment groups comprises:
receiving information defining a cellular telephone number (CTN) associated with each designated payer, wherein the communication services comprise cellular communication services over a cellular network of a network operator.

7. The device of claim 1, wherein the
subscriber corresponds to the first designated payer, the non-payer, or the second designated payer.

8. The device of claim 1, wherein the receiving information defining the first and second payment groups further comprises:
receiving information adding an additional non-payer to the first or second payment group or receiving information removing the non-payer from the first payment group.

9. The device of claim 1, wherein the operations further comprise:
receiving, from the interface, information defining the first and second designated amounts due.

10. The device of claim 9, wherein the operations further comprise:
receiving, from the interface, information defining the first and second designated amounts due as substantially equal amounts.

11. A non-transitory machine-readable medium, comprising executable instructions that, when executed by a processing system including a processor, facilitate performance of operations, the operations comprising:
receiving, from a subscriber device, information defining a plurality of designated payers and respective assigned portions of amounts due for payment to a subscription account associated with the subscriber for communication services;
receiving, from the subscriber device, grouping information which defines a plurality of payment groups, the grouping information including information defining a particular one of the designated payers for each payment group and information defining one or more non-paying users associated with the subscription account, each of the one or more non-paying users being assigned to one of the plurality of payment groups;
sending, to a device of each of the designated payers, a communication indicating the respective assigned portion of amounts currently due for payment to the subscription account, the communication further indicating a respective payment mechanism for actuation by each designated payer;
receiving, from the device of each of the designated payers, a respective authorization of payment through the respective payment mechanism; and
crediting the subscription account according to the respective authorizations of payment.

12. The non-transitory machine-readable medium of claim 11, wherein the operations further comprise:
receiving, from the subscriber device, information adding an additional non-paying user to one of the plurality of payment groups or receiving, from the subscriber device, information removing one of the one or more non-paying users from one of the plurality of payment groups.

13. The non-transitory machine-readable medium of claim 12, wherein the operations further comprise:
receiving, from the subscriber device, grouping information which defines the respective assigned amount currently due for payment to the subscription account from each respective designated payer.

14. The non-transitory machine-readable medium of claim 11, wherein the operations further comprise:
determining a payment status for each designated payer; and
providing, to the subscriber device, payment status information for the designated payers, the payment status information based on the payment status for each designated payer.

15. The non-transitory machine-readable medium of claim 14, wherein the operations further comprise:
providing, for the subscriber device, an interface; and
receiving, from the subscriber device at the interface, information defining each designated payer for an initial enrollment in a shared payment service.

16. The non-transitory machine-readable medium of claim 15, wherein the operations further comprise:
receiving, from the subscriber device at the interface, a status inquiry for a current billing cycle for the subscription account; and
providing, to the subscriber device at the interface, the payment status information for the current billing cycle.

17. A method, comprising:
receiving, by a processing system including a processor, from a subscriber associated with a subscription account shared by a plurality of users for accessing communication services, information defining one or more designated payers, each designated payer of the one or more designated payers being responsible for payment of a designated portion of amounts due for payment to the subscription account;
communicating, by the processing system, periodically according to a billing cycle for the subscription account, to each designated payer, a payment communication indicating a designated amount due from the designated payer, the payment communication including a payment mechanism which may be actuated by the designated payer for completing a payment of the designated amount to the subscription account;
receiving, by the processing system, from the subscriber, grouping information, the grouping information defining one or more payment groups, the grouping information including information defining a designated payer for each payment group and information defining one or more users of the plurality of users associated with the subscription account assigned to each payment group;
receiving, by the processing system, from the designated payer of each payment group, an authorization of payment of the designated amount through the payment mechanism; and
crediting, by the processing system, the subscription account according to the authorization of payment.

18. The method of claim 17, comprising:
receiving, by the processing system, from the subscriber, information designating the one or more users as non-paying users.

19. The method of claim 17, wherein communicating the payment communication comprises:
communicating, by the processing system, to the designated payer, a message including a payment link to a payment web page, the payment link actuatable by the designated payer to access the payment web page to authorize payment of the designated amount.

20. The method of claim 19, wherein communicating the payment communication further comprises:
communicating, by the processing system, the message including a direct payment actuator wherein the direct payment actuator is responsive to actuation in the message by the designated payer to immediately authorize the payment of the designated amount.
